(19) United States
(12) Patent Application Publication
(10) Pub. No.: US 2022/0327027 A1
(43) Pub. Date: Oct. 13, 2022

(54) UNIVERSAL TAPE-DATA BACKUP AND RESTORE SYSTEM

(71) Applicant: Stephen R. Johnson, Kennesaw, GA (US)

(72) Inventor: Stephen R. Johnson, Kennesaw, GA (US)

(21) Appl. No.: 17/301,751

(22) Filed: Apr. 13, 2021

(51) Int. Cl. G06F 11/14

(52) U.S. Cl. CPC G06F 11/1456

(57) ABSTRACT

A self-contained, mobile, universal tape data backup and restore hardware and software appliance is disclosed. The invention eliminates the need to use native hardware and software installed in a data center environment. The appliance utilizes a plurality of tape backup drives for reading a backup dataset of carried on a tape backup. The appliance includes a processor and memory to implement a backup platform plugin manager that is configured determine a native format of the backup data set and selects a specific back platform plugin that corresponds with the native format of the backup data set to restore the backup data set in the native format.

### BACKGROUND OF THE INVENTION

The present invention relates to computer backup and restore systems, and more particularly to portable backup and restore systems.

Most data in a data center is backed up to a magnetic tape using a native hardware and software installed in the data center environment. This is often very expensive and takes up a large physical footprint.

As can be seen, there is a need for a small footprint, mobile and portable backup and restore appliance and a universal software that enables data to be backed up and/or restored without the need or reliance on native hardware and/or software.

### SUMMARY OF THE INVENTION

In one aspect of the present invention, a universal backup and restore appliance. The appliance includes, a computer having at least one processor, a plurality of tape backup drives; and at least one memory including computer program code, the at least one memory and the computer program code configured to, with the at least one processor, cause the computer to perform process steps. The process steps include reading, by a backup platform plugin manager, a header data contained in a header of a backup data set from a backup tape inserted into at least one of the plurality of tape backup drives. The backup platform plugin manager then determines a native format of the backup data set. The backup platform plugin manager selects a specific backup platform plugin corresponding to the native format of the backup data set. The specific backup platform plugin deciphers the backup data set according to the native format of the backup data set.

In some embodiments, the specific backup platform plugin writes a restored version of the backup data set according to the native format.

In some embodiments, the specific backup platform plugin traverses the backup data set contained on the backup tape. Data carried in the backup data set is restored to the native format using a de-encapsulation method according to the native format used to create the backup data set.

In some embodiments a second backup tape containing a second backup data set is received in another of the plurality of tape backup drives. The backup platform plugin manager, reads a second header data contained in the header of a second backup data set from the second backup tape inserted into another of the plurality of tape backup drives. The backup platform plugin manager determines a native format of the second backup data set and selects a second specific backup platform plugin corresponding to the native format of the second backup data set.

In some embodiments, the second backup data set is deciphered by the second specific backup platform plugin, according to the native format of the second backup data set.

In some embodiments, the second specific backup platform plugin traverses the second backup data set contained on the second backup tape. The second specific backup platform plugin, data carried in the backup data set to the native file format using a de-encapsulation method according to the native format used to create the backup data set.

In some embodiments, the second backup data set concurrently deciphered with the first backup data set.

These and other features, aspects and advantages of the present invention will become better understood with reference to the following drawings, description and claims.

### BRIEF DESCRIPTION OF THE DRAWINGS

FIG. 1 is a front perspective view of a universal backup and restore appliance.

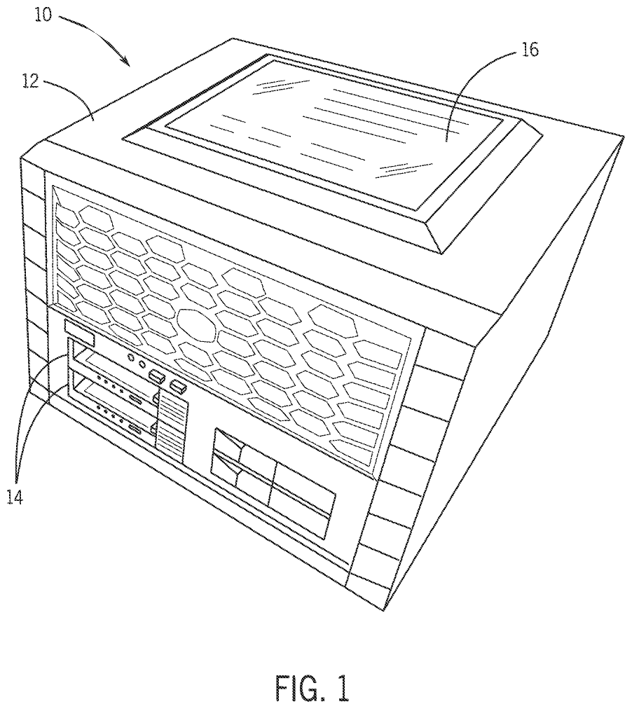

FIG. 2 is a front elevation view of the universal backup and restore appliance.

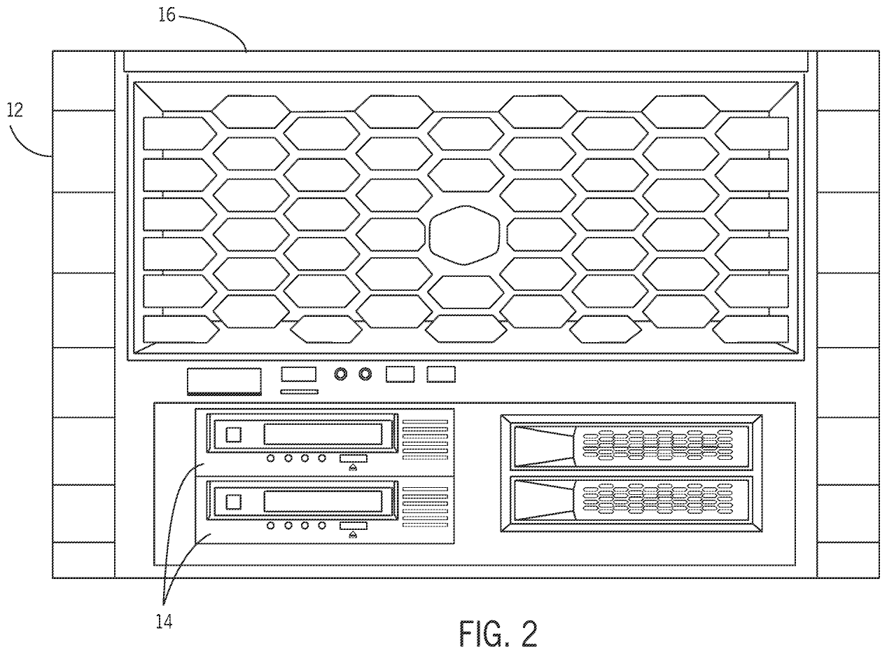

FIG. 3 is a block diagram, showing components of the universal backup and restore appliance.

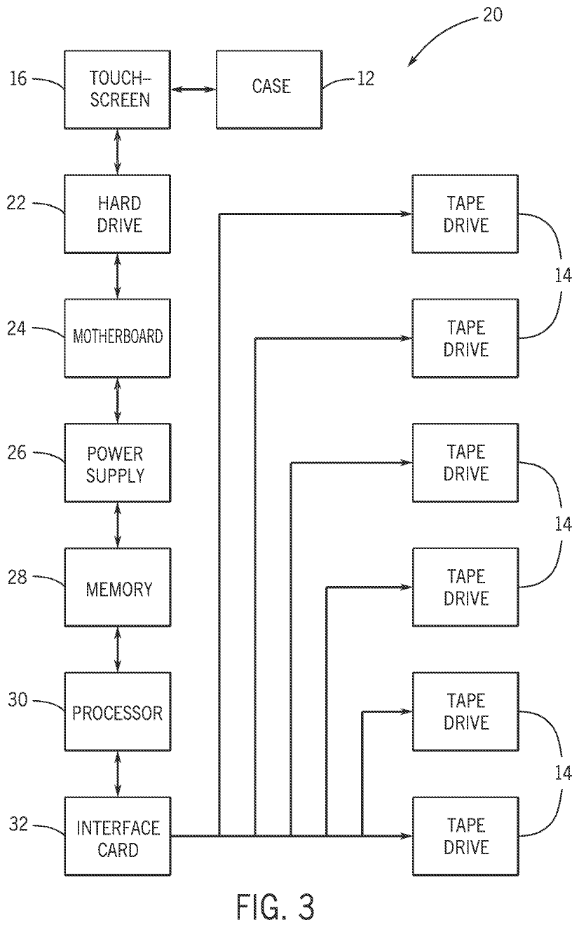

FIG. 4 is second block diagram showing components of the universal backup and restore appliance.

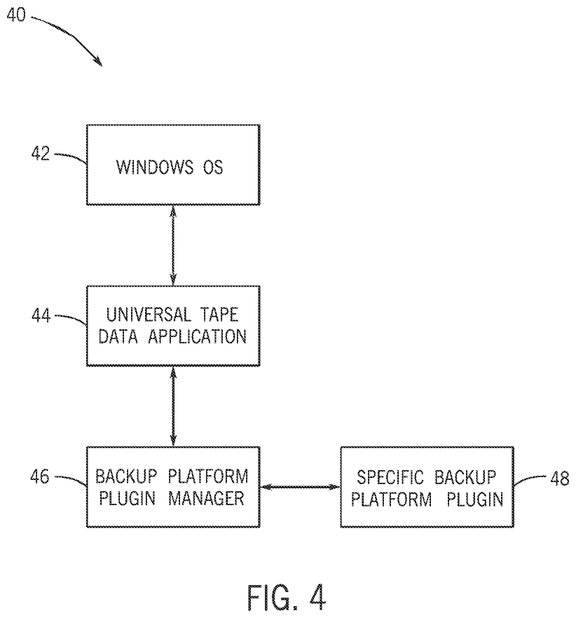

FIG. 5 is a diagram sowing a software component of showing components of the universal backup and restore appliance.

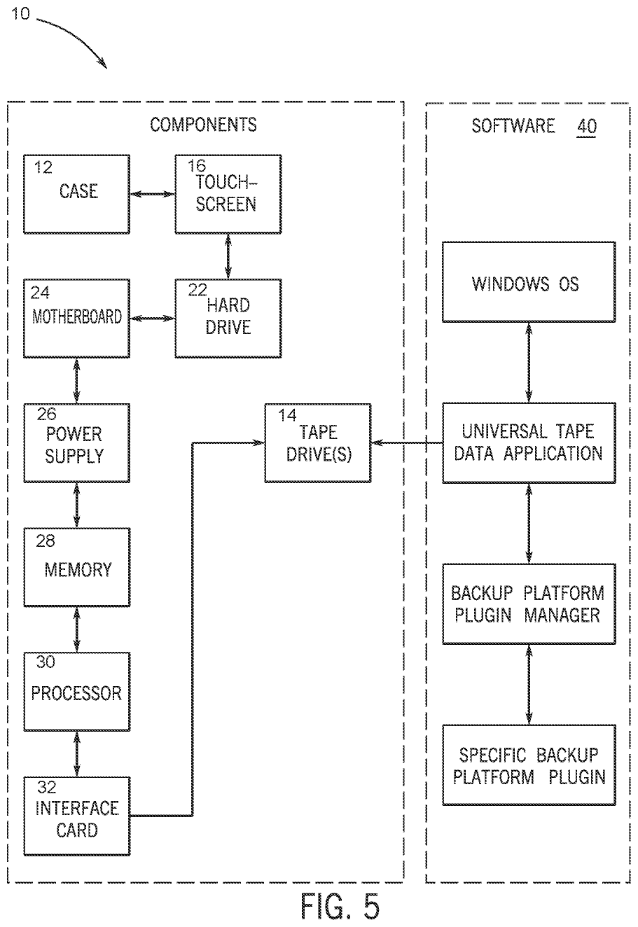

FIG. 6 is a flowchart for implementing a restoration of a backup data set.

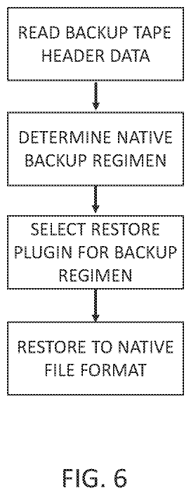

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention enables data to be backed up and/or restored to magnetic tape anywhere in the world. It can eliminate the need to use native data backup and restore hardware and software in a data center environment. The present invention can also eliminate the need for a large physical footprint in a data center.

The invention solves the problem of backing up and/or restoring data stored on backup, magnetic tape via a mobile, portable, self-contained appliance 10 with universal backup and restore software which supports non-native backup and/or restore of data to a magnetic tape.

The universal backup appliance 10 is housed in a computer case 12. The computer case may include a Mini-ITX computer case. The computer case 12 contains a plurality of tape backup and restore drives 14 accessible through a face of the computer case 12. The appliance 10 is operable through interaction with a touch screen display 16. Alternatively, the appliance 10 may be controlled by a display, a keyboard, or other interface.

The universal backup and restore appliance 10 includes: a hard drive 22, such as an internal SSD hard drive; a motherboard 24, such as an AM4 M.2 USB 3 DDR4 HDMI Display Port Mini-ITX Motherboard; a power supply 26, such as an 850-Watt modular power supply, and a memory 28; such as 16 GB (2×8 GB) DDR4 DRAM 3000 MHz C15 Desktop Memory. A processor 30, such as AMD Processor; and an interface card 32. The plurality of tape backup and restore drives 14 connect with the appliance via the interface card 32, such as a Half height internal LTO class tape drive. SAS interface internal SSD hard drive.

A software component 40 controls operation of the universal backup and restore appliance 10 and the reading and writing of a backup tape carried in the drives 14. The software component 40 includes an appliance operating system 42, such as the Windows® operating system. The software component 40 includes a universal tape data application 44 that can read from and write a backup data set from a backup tape regardless of the native format of the back up tape or the hardware employed to create the tape. A backup platform plugin manager 46 allows a system operator to conduct backup and restore operations by selecting from one or more specific backup platform plugins 48.

The backup platform plugin manager 46 interacts to instruct the appliance 10 in the following way. As a tape containing a backup data set is inserted in one of the plurality of tape drives 14, commands are initiated to restore the dataset on the tape. The commands instruct the processor to read a header of the backup data set carried on the tape being read by the tape drive 14. The header is typically contained in the first 8 to 16 bytes of the backup data set. The header information is then processed to determine a backup platform used to create the backup the data contained on the backup tape.

Once the backup platform is determined from the header information, the backup platform plugin manager 46 selects a corresponding specific backup platform plugin 48 for the backup platform. The corresponding “plugin” is configured to decipher the backup data set from its native format and create a restored data set according to the native format of the backup data set.

The specific backup platform plugin 48 then traverses the backup data set contained on tape and restores data carried on the tape to the native file format using a de-encapsulation method comparable to the native software used to back up the data. The restored data may then be written to the hard drive 22 or another of the plurality of tape backup drives 14.

The interface for controlling the plurality of backup drives 14 permits the appliance 10 to simultaneously restoring backup tapes having backup data sets having different file backup regimens.

It should be understood, of course, that the foregoing relates to exemplary embodiments of the invention and that modifications may be made without departing from the spirit and scope of the invention as set forth in the following claims.

What is claimed is:

1. A universal backup and restore appliance, comprising:
a computer having at least one processor;
a plurality of tape backup drives; and
at least one memory including computer program code, the at least one memory and the computer program code configured to, with the at least one processor, cause the computer to at least:
reading, by a backup platform plugin manager, a header data contained in a header of a backup data set from a backup tape inserted into at least one of the plurality of tape backup drives;
determine, by the backup platform plugin manager, a native format of the backup data set;
selecting, by the backup platform plugin manager, a specific backup platform plugin corresponding to the native format of the backup data set; and
deciphering, by the specific backup platform plugin, the backup data set according to the native format of the backup data set.

2. The universal backup and restore appliance of claim 1, further comprising:
writing, by the specific backup platform plugin, a restored version of the backup data set according to the native format.

3. The universal backup and restore appliance of claim 1, further comprising:
traversing, by the specific backup platform plugin, the backup data set contained on the backup tape; and
restoring, by the specific backup platform plugin, data carried in the backup data set to the native format using a de-encapsulation method according to the native format used to create the backup data set.

4. The universal backup and restore appliance of claim 3, further comprising:
receiving in another of the plurality of tape backup drives, a second backup tape containing a second backup data set;
reading, by a backup platform plugin manager, a second header data contained in the header of a second backup data set from a second backup tape inserted into another of the plurality of tape backup drives;
determining, by the backup platform plugin manager, a second native format of the second backup data set; and
selecting, by the backup platform plugin manager, a second specific backup platform plugin corresponding to the native format of the second backup data set.

5. The universal backup and restore appliance of claim 4, further comprising:
deciphering, the second backup data set, by the second specific backup platform plugin, according to the native format of the second backup data set.

6. The universal backup and restore appliance of claim 4, further comprising:
traversing, by the second specific backup platform plugin, the second backup data set contained on the backup tape; and
restoring, by the second specific backup platform plugin, data carried in the second backup data set to a second native file format using a de-encapsulation method according to the native format used to create the second backup data set.

7. The universal backup and restore appliance of claim 4, further comprising:
deciphering the second backup data set concurrently with the backup data set.
